(19) United States
(12) Patent Application Publication
(10) Pub. No.: US 2024/0159861 A1
(43) Pub. Date: May 16, 2024

(54) POINT CLOUD REPORTING IN CELLULAR SYSTEMS

(71) Applicant: QUALCOMM Incorporated, San Diego, CA (US)

(72) Inventors: Marwen ZORGUI, San Diego, CA (US); Srinivas YERRAMALLI, San Diego, CA (US); Rajat PRAKASH, San Diego, CA (US); Xiaoxia ZHANG, San Diego, CA (US)

(21) Appl. No.: 18/054,512

(22) Filed: Nov. 10, 2022

(51) Int. Cl. G01S 7/00; H04W 4/38

(52) U.S. Cl. CPC G01S 7/003; H04W 4/38

(57) ABSTRACT

A first network entity may identify a point cloud including a plurality of points associated with RF sensing. The first network entity may transmit an indication of the point cloud for a second network entity. The second network entity may perform a sensing operation based on the received point cloud. The point cloud may be based on one or more radar data cubes. Each point in the plurality of points may be associated with at least one of a range, a velocity, or one or more angles. The point cloud may be associated with a local coordinate system associated with the first network entity or a global coordinate system.

### TECHNICAL FIELD

The present disclosure relates generally to communication systems, and more particularly, to point cloud reporting associated with radio frequency (RF) sensing in a wireless communication system.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a first network node. The apparatus may identify a point cloud including a plurality of points associated with RF sensing. The apparatus may transmit an indication of the point cloud for a second network entity.

In an aspect of the disclosure, a method, a computer-readable medium, and an apparatus are provided. The apparatus may be a second network node. The apparatus may receive a point cloud including a plurality of points associated with RF sensing from a first network entity. The apparatus may perform a sensing operation based on the received point cloud.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a UE positioning based on reference signal measurements.

FIG. 5 is a diagram illustrating example radar data cube generation.

FIG. 6 is a diagram of a communication flow of a method of wireless communication.

FIG. 7 is a flowchart of a method of wireless communication.

FIG. 8 is a flowchart of a method of wireless communication.

FIG. 9 is a flowchart of a method of wireless communication.

FIG. 10 is a flowchart of a method of wireless communication.

FIG. 11 is a diagram illustrating an example of a hardware implementation for an example apparatus and/or network entity.

FIG. 12 is a diagram illustrating an example of a hardware implementation for an example network entity.

FIG. 13 is a diagram illustrating an example of a hardware implementation for an example network entity.

### DETAILED DESCRIPTION

Generating a point cloud and reporting the point cloud to a sensing entity (e.g., by a reporting network entity performing RF sensing) in a wireless communication system may be an important operation in the context cellular wireless communication system-based RF sensing.

In one or more aspects, a first network entity may identify a point cloud including a plurality of points associated with RF sensing. The first network entity may transmit an indication of the point cloud for a second network entity. The second network entity may perform a sensing operation based on the received point cloud. Accordingly, the reporting of point clouds to a sensing entity by a reporting network entity may be enabled.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR B S, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

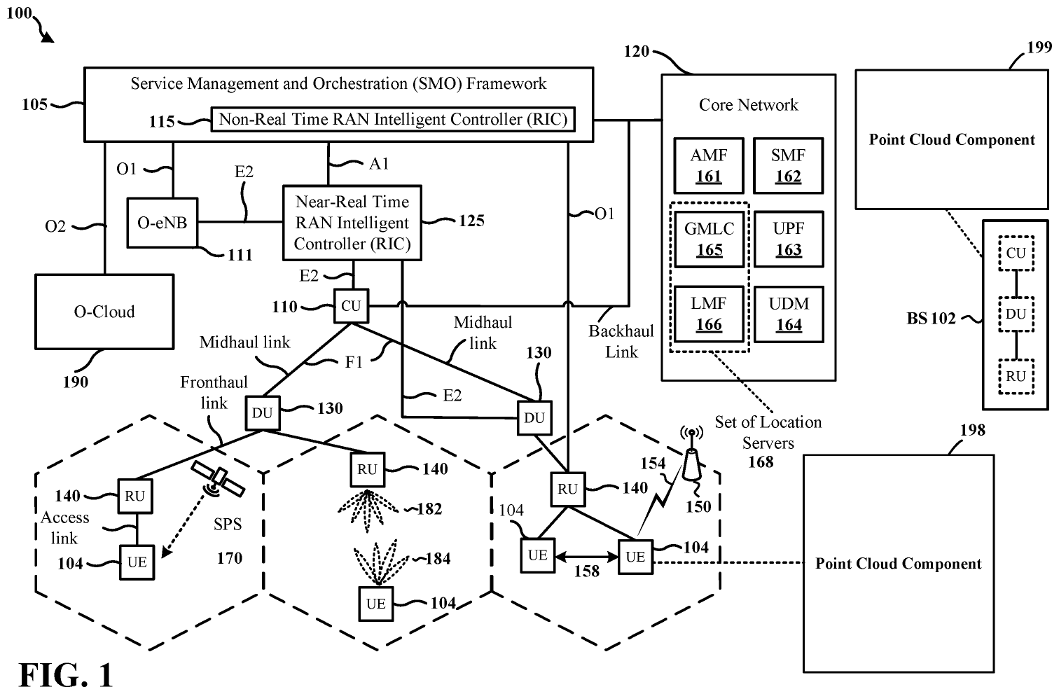

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (MC) 125 via an E2 link, or a Non-Real Time (Non-RT) MC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit—User Plane (CU-UP)), control plane functionality (i.e., Central Unit—Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TB S), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 (operating as a first network entity) may include a point cloud component 198 that may be configured to identify a point cloud including a plurality of points associated with RF sensing. The point cloud component 198 may be configured to transmit an indication of the point cloud for a second network entity. In certain aspects, the base station 102 (operating as a first network entity) may include a point cloud component 199 that may be configured to identify a point cloud including a plurality of points associated with RF sensing. The point cloud component 199 may be configured to transmit an indication of the point cloud for a second network entity. Although the following description may be focused on 5G NR, the concepts described herein may be applicable to other similar areas, such as LTE, LTE-A, CDMA, GSM, and other wireless technologies.

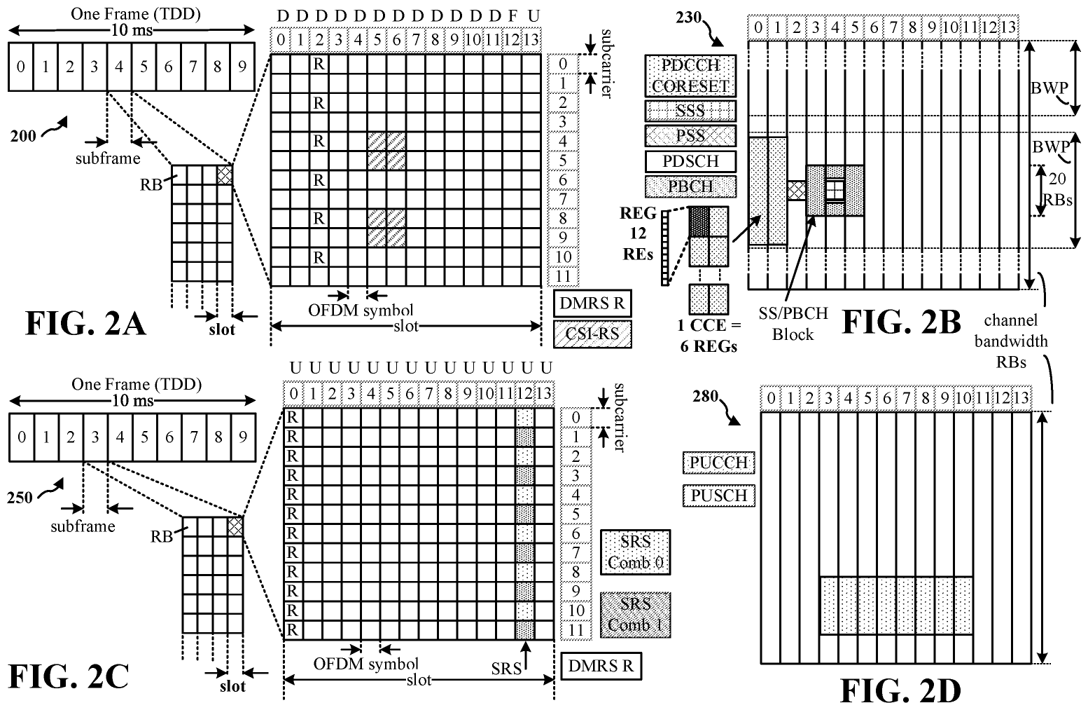

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

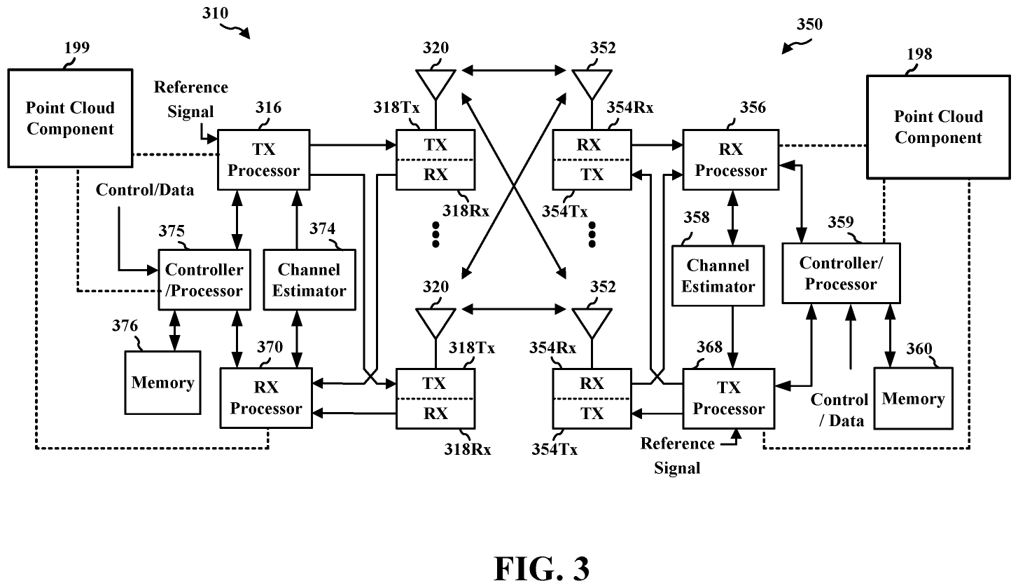

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the point cloud component 198 of FIG. 1.

At least one of the TX processor 316, the RX processor 370, and the controller/processor 375 may be configured to perform aspects in connection with the point cloud component 199 of FIG. 1.

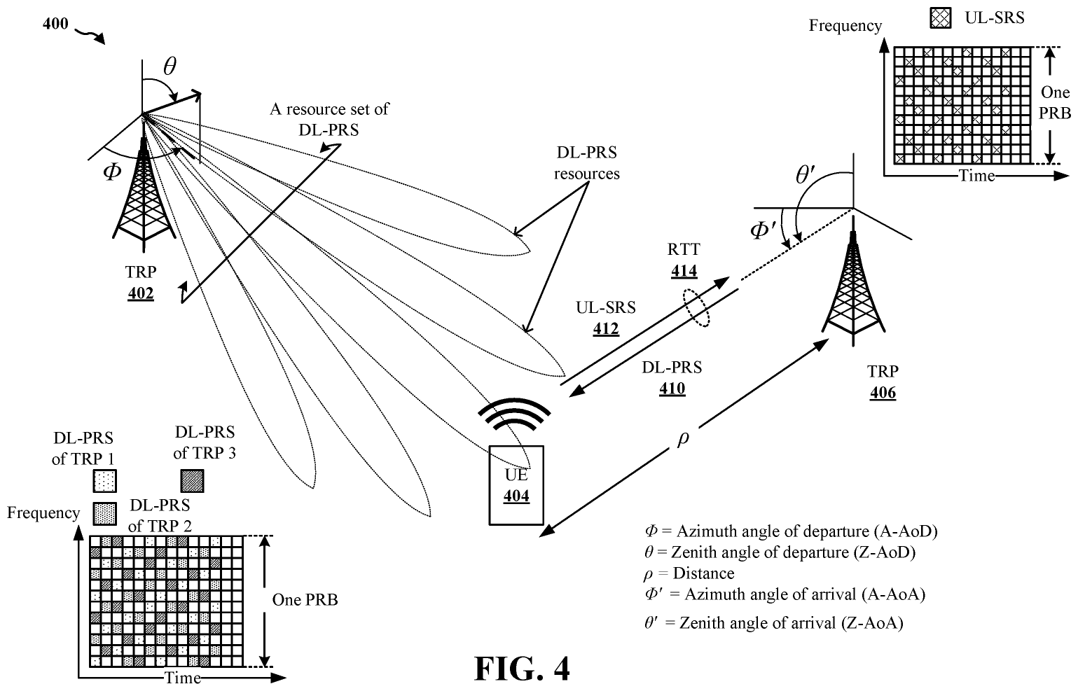

FIG. 4 is a diagram 400 illustrating an example of a UE positioning based on reference signal measurements. The UE 404 may transmit UL-SRS 412 at time T_{SRS_TX} and receive DL positioning reference signals (PRS) (DL-PRS) 410 at time T_{PRS_RX}. The TRP 406 may receive the UL-SRS 412 at time T_{SRS_RX} and transmit the DL-PRS 410 at time T_{PRS_TX}. The UE 404 may receive the DL-PRS 410 before transmitting the UL-SRS 412, or may transmit the UL-SRS 412 before receiving the DL-PRS 410. In both cases, a positioning server (e.g., location server(s)168) or the UE 404 may determine the RTT 414 based on ∥T_{SRS_RX}|T_{PRS_TX}|−T_{SRS_TX}−T_{PRS_RX}∥ Accordingly, multi-RTT positioning may make use of the UE Rx-Tx time difference measurements (i.e., |T_{SRS_TX}−T_{PRS_RX}|) and DL-PRS reference signal received power (RSRP) (DL-PRS-RSRP) of downlink signals received from multiple TRPs 402, 406 and measured by the UE 404, and the measured TRP Rx-Tx time difference measurements (i.e., |T_{SRS_RX}−T_{PRS_TX}|) and UL-SRS-RSRP at multiple TRPs 402, 406 of uplink signals transmitted from UE 404. The UE 404 measures the UE Rx-Tx time difference measurements (and DL-PRS-RSRP of the received signals) using assistance data received from the positioning server, and the TRPs 402, 406 measure the gNB Rx-Tx time difference measurements (and UL-SRS-RSRP of the received signals) using assistance data received from the positioning server. The measurements may be used at the positioning server or the UE 404 to determine the RTT, which is used to estimate the location of the UE 404. Other methods are possible for determining the RTT, such as for example using DL-TDOA and/or UL-TDOA measurements.

DL-AoD positioning may make use of the measured DL-PRS-RSRP of downlink signals received from multiple TRPs 402, 406 at the UE 404. The UE 404 measures the DL-PRS-RSRP of the received signals using assistance data received from the positioning server, and the resulting measurements are used along with the azimuth angle of departure (A-AoD), the zenith angle of departure (Z-AoD), and other configuration information to locate the UE 404 in relation to the neighboring TRPs 402, 406.

DL-TDOA positioning may make use of the DL reference signal time difference (RSTD) (and DL-PRS-RSRP) of downlink signals received from multiple TRPs 402, 406 at the UE 404. The UE 404 measures the DL RSTD (and DL-PRS-RSRP) of the received signals using assistance data received from the positioning server, and the resulting measurements are used along with other configuration information to locate the UE 404 in relation to the neighboring TRPs 402, 406.

UL-TDOA positioning may make use of the UL relative time of arrival (RTOA) (and UL-SRS-RSRP) at multiple TRPs 402, 406 of uplink signals transmitted from UE 404. The TRPs 402, 406 measure the UL-RTOA (and UL-SRS-RSRP) of the received signals using assistance data received from the positioning server, and the resulting measurements are used along with other configuration information to estimate the location of the UE 404.

UL-AoA positioning may make use of the measured azimuth angle of arrival (A-AoA) and zenith angle of arrival (Z-AoA) at multiple TRPs 402, 406 of uplink signals transmitted from the UE 404. The TRPs 402, 406 measure the A-AoA and the Z-AoA of the received signals using assistance data received from the positioning server, and the resulting measurements are used along with other configuration information to estimate the location of the UE 404.

Additional positioning methods may be used for estimating the location of the UE 404, such as for example, UE-side UL-AoD and/or DL-AoA. Note that data/measurements from various technologies may be combined in various ways to increase accuracy, to determine and/or to enhance certainty, to supplement/complement measurements, and/or to substitute/provide for missing information.

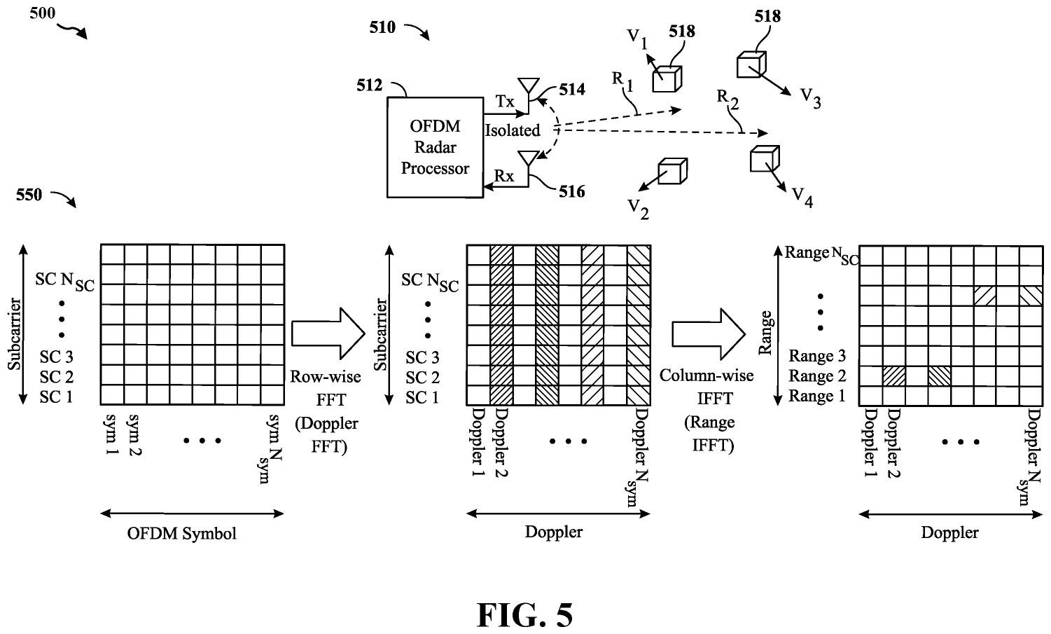

FIG. 5 is a diagram 500 illustrating example radar data cube generation. The diagram 510 illustrates example RF sensing. At a reporting network entity, RF signals transmitted via a transmit RF chain 514 may be reflected by one or more objects 518 (e.g., 4 objects 518) in the environment. As shown, two of the objects 518 may be at a range R₁ from the node that performs sensing and may be moving with velocities V₁ and V₂, respectively. Further, another two of the objects 518 may be at a range R₂ (greater than R₁) from the node that performs sensing and may be moving with velocities V₃ and V₄, respectively. The receive RF chain 516 may receive the reflected RF signals. Based on the received reflected RF signals, the radar processor 512 (e.g., an OFDM radar processor) (e.g., at the node that performs sensing) may generate one or more radar data cubes. In some configurations, as shown in the diagram 550, a radar data cube may be generated through applying a two-dimensional (2D) FFT operation on the baseband in-phase and quadrature (IQ) samples of the received OFDM samples, where the first dimension of the FFT may be across time (also known as slow-time FFT or row-wise/Doppler FFT) and the second FFT may be along the frequency (e.g., subcarrier) domain (also known as fast-time FFT or column-wise/range FFT). As shown, after the row-wise/Doppler FFT, the Doppler values corresponding to the object velocities may be highlighted (i.e., these columns may have higher values than other values). Further, after the column-wise/range FFT, the actual ranges may be located. Accordingly, the rows corresponding to R₁ and R₂ may have higher values. Therefore, as the column-wise/range FFT is performed after the row-wise/Doppler FFT, the 4 entries in the matrix with higher values (compared to other entries) corresponding to the 4 objects 518 may be highlighted. Other ways of generating a radar data cube may be used in additional configurations. For example, super-resolution algorithms (e.g., multiple signal classification (MUSIC), estimation of signal parameters via rotational invariance technique (ESPRIT), etc.) instead of FFT operations may be used to obtain more accurate results (which may be at the expense of higher computational complexity).

RF sensing may become a major use case in future cellular wireless communication networks. With RF sensing, RF signals may be used to acquire information about characteristics of the environment and of objects within the environment (e.g., shape, size, speed, location, distances, or relative motions between objects, etc.). Dedicated frequency and time domain resources may be used for sensing operations. Typically, a device may perform sensing operations by scanning an area using RF beams. For example, the device may scan an area by sweeping across multiple beams.

The RF sensing may be further applicable to different use cases. Examples of the use cases of the RF sensing may include joint communication-sensing, environment scanning, object detection, weather monitoring, and so on.

In some configurations, a wireless communication system (e.g., a 5G NR system or another wireless communication system) may support the RF sensing and collection of sensing measurement data. The wireless communication system may support the reporting of the sensing measurement data for processing, Further, the wireless communication system may support the processing of the sensing measurement data including correlating (associating) the sensing measurement data with other assisted information (e.g., location information). Moreover, the wireless communication system may support the exporting (exposing) of the sensing measurement data and the sensing results to a third-party application (e.g., an authorized third-party application) (e.g., via the core network).

In some configurations, for sensing purposes, a UE may be configured to report time domain and/or frequency domain samples of the received waveform to the network. In some configurations, a UE may be configured to report a radar data cube (e.g., a full matrix) to the network. In particular, a point cloud may be generated based on postprocessing of the sensing data or radar data. A point cloud may be a set of n-dimensional points, where each dimension may correspond to a feature/characteristic of the object (e.g., range, Doppler, angle, etc.). A point cloud may be regarded as a refined output of one or multiple radar data cubes. Accordingly, multiple radar data cubes may be combined to generate a point cloud. Further, additional processing operations may be performed to obtain a point cloud. The additional processing operations may include, for example, constant false alarm rate (CFAR) detection, range/Doppler/angle ambiguity resolution, averaging of multiple frames or captures, and so on.

In some configurations, the point clouds may be the input to AI/ML-based algorithms with applications such as semantic segmentation, detection, or object classification (e.g., for automotive use cases). Accordingly, generating a point cloud and reporting the point cloud to a sensing entity in a wireless communication system may be an important operation in the context of cellular wireless communication system-based RF sensing.

In one or more aspects, a network entity (e.g., a UE, a base station, or a TRP) may report one or more point clouds to a sensing entity in a wireless communication system. The point clouds may be structured to facilitate the reporting. Further, a configuration of point cloud reporting may be specified (e.g., by the sensing entity). Herein the sensing entity may also be referred to as the sensing management entity. In further configurations, the network entity (e.g., the UE, the base station, or the TRP) may provide an indication of node capabilities of the network entity relating to the reporting/signaling of point clouds.

In one or more configurations, a point cloud information element (IE) (e.g., an IE named “PointCloudIE”) may be defined for the point cloud reporting. In one configuration, a point cloud IE may include point cloud elements (e.g., parameters named “PointCloudElement”), which may be defined in a coordinate system. In particular, a point cloud element parameter may include such fields as a range, a velocity, an angle (e.g., an azimuth and/or an elevation), and so on.

For the range, a mapping of an integer to a range value may be specified and used. For example, for fixed step reporting granularity, a step length (ΔR) may be specified and defined. Accordingly, the maximum reportable range may be ΔR*maximum integer (e.g., ΔR*range−Range). In different examples, different mapping rules (i.e., for mapping from the integer to the range value) may be defined based on intervals. Similarly, for the velocity, a mapping of an integer to a velocity value may be specified and used. For example, a step length (Δv) for the velocity may be specified and defined. The step length for the velocity may determine the maximum reportable velocity.

Further, for the angle, a reporting step length may be specified. For example, if the step length (scale factor) is 1 degree, the azimuth may be reported with a range between 0 and 359 degrees at the 1-degree granularity, and the elevation may be reported with a range between 0 and 180 degrees at the 1-degree granularity. In another example, the reporting of the angle may be at finer granularity. For example, a step length (scale factor) of 0.1 degrees may be used. Accordingly, for example, instead of being reported as being 0 degrees or 1 degree, an angle may be reported in the range between 0 and 0.9 degrees at the 0.1-degree granularity.

In different configurations, a point cloud may be reported with respect to a local coordinate system or a global coordinate system. If a local coordinate system is used, the point cloud report may include an indication (report) of the center of the local coordinate system. The center of the local coordinate system may be indicated directly (i.e., indicated using an absolute position) or through the specification of an offset with respect to a known position (i.e., a reference). For example, for a UE reporting the point cloud, the reference may be the position of the UE. In another example, for a TRP reporting the point cloud, the reference may be the antenna reference point (ARP) of the TRP. In additional configurations, if a global coordinate system is used, the coordinate system of the point clouds may be reported/indicated together with the points in the point clouds. Furthermore, a framework for translating between a local coordinate system and a global coordinate system (e.g., a framework associated with the “lcs-GCS-TranslationParameter” parameter) may be used.

In one or more configurations, prior to configuring a network entity (e.g., a UE, a base station, or a TRP) with point cloud reporting, the sensing entity may want to know whether the network entity supports point cloud reporting. Accordingly, in some configurations, a network entity (e.g., a UE, a base station, or a TRP) may indicate its point cloud reporting capabilities to the sensing entity. The indication of the point cloud reporting capabilities may be provided as part of the indication of sensing-related capabilities.

The indication of the point cloud reporting capabilities may include indications of different capabilities at different levels of granularity. In one configuration, the indication of the point cloud reporting capabilities may include an indication of the properties (e.g., range, velocity, angle, etc.) (e.g., all properties or a subset of properties) that may be reported in the IE (i.e., IE parameters). In one configuration, the indication of the point cloud reporting capabilities may include an indication of supported coordinate systems (e.g., a local coordinate system and/or a global coordinate system). In one configuration, the indication of the point cloud reporting capabilities may include an indication of the reporting format (e.g., a reporting device/network entity may not be able to keep track of whole point clouds, and may just report the fresh (new) cloud point on each reporting occasion). In one configuration, the indication of the point cloud reporting capabilities may include an indication of frequencies supported by the reporting network entity and/or an antenna configuration for each frequency. In one configuration, the indication of the point cloud reporting capabilities may include an indication of a beam pattern configuration.

In one or more configurations, the sensing entity may configure a reporting network entity/node (e.g., a UE, a base station, or a TRP) for point cloud reporting (e.g., by transmitting a configuration for point cloud reporting). The configuration for point cloud reporting may include one or more of a sensing RS configuration, a reporting frequency configuration, a reporting format configuration, and so on.

For the sensing RS configuration, the resources (e.g., time-frequency resources) for the sensing RSs to be used for generating the point clouds may be configured. In one configuration, resources may be specifically configured for the generation of the point clouds. In another configuration, based on the sensing RS configuration, existing resources (e.g., an already configured positioning RS, or another already configured sensing RS, etc.) may be used for the generation of the point clouds. If existing resources are to be used for the generation of the point clouds, the sensing RS configuration may indicate the resources associated with the already configured sensing RS to be used for the generation of the point clouds. For example, a TRP may use the same positioning RS for both positioning and RF sensing. Further, in one configuration, within the sensing RS configuration, for Doppler estimation, the number of instances (e.g., across time) to be used for Doppler estimation may be indicated.

In some configurations, the network entity/node transmitting the sensing RS may be different from the network entity/node receiving the sensing RS (i.e., bistatic sensing). If bistatic sensing is used, the sensing RS configuration may include assisting data for the receiving network entity/node. For example, the assisting data may include the sensing RS resource configuration, an indication of the location of the transmitting network entity/node, an indication of the velocity of the transmitting network entity/node, and so on. In one configuration, the point cloud report may include an indication of whether the report is generated based on monostatic sensing (i.e., RF sensing where the transmitting network entity/node and the receiving network entity/node may be the same network entity/node) or bistatic sensing.

In one example configuration, for the reporting frequency configuration, the configuration for point cloud reporting may indicate that a point cloud report may be generated/requested/provided following every n-th transmission of the sensing RS (the sensing RS may be specified in the sensing RS configuration described above).

For the reporting format configuration, in one configuration, on each reporting occasion, the reporting network entity may report a point cloud independently from previously reported point clouds. In another configuration, differential reporting may be used. In particular, the full point cloud may be reported on the first reporting occasion. Thereafter, on subsequent reporting occasions, modifications/differences with respect to the point cloud (map) reported on the previous occasion may be indicated in the point cloud report (e.g., newly appearing points may be indicated in the report and points that have disappeared/do not exist anymore may also be indicated in the report). To enable differential reporting, each point may be associated with an index/identifier (ID), such that existing, disappearing, and newly appearing points in the point cloud may be tracked. In one example, a supported maximum number of point indexes/IDs may be specified. In one example, the index/ID of a point that has disappeared may be reused for a newly appearing point on a later occasion.

In one or more configurations, the configuration for point cloud reporting may specify whether velocity compensation is to be used. The velocity compensation may be enabled or disable at the time of point cloud reporting based on the configuration. For example, if the transmitting network entity/node or the receiving network entity/node is moving, velocity compensation may be enabled and applied. For example, if a vehicle UE (reporting network entity/node) is moving, static objects around the vehicle UE may appear to have non-zero velocities because the output of the RF sensing at the vehicle UE may detect object velocities as they relate to the vehicle UE. For instance, a tree in the environment may appear as a detected object with a certain non-zero velocity. In this situation, the sensing entity may request that the reporting vehicle UE apply velocity compensation to the generated point cloud to correct for the motion of the vehicle UE. Because the vehicle UE knows its own speed and direction, the vehicle UE may compensate for its own motion so that detected stationery objects (e.g., the tree) have a zero velocity in the point cloud. In another example, the vehicle UE may not directly apply velocity compensation. Instead, the vehicle UE may include information about its motion (velocity, orientation, etc.) in the point cloud report. Then, the sensing entity may apply compensation to the received point cloud report based on the information about the motion of the vehicle UE.

In one or more configurations, the configuration for point cloud reporting may specify one or more reporting conditions. For example, bounds on the reported cloud points may be specified. The bounds may relate to a minimum range, a maximum range, or both a minimum range and a maximum range. In one example, based on the configured bounds, the reporting network entity may report just points in a point cloud within a range that exceeds a configured (minimum) value. In other words, the reporting network entity may exclude points that fall below the range in the point cloud report. In different configurations, other similar bounds may be configured/specified for one or more of velocity, angle (azimuth and/or elevation), and so on.

In one or more configurations, the configuration for point cloud reporting may specify a coordinate system representation (e.g., polar representation or Cartesian representation). For example, by default, the range/angle (r, theta) representation may be a polar representation of the cloud point locations in the reference coordinate system. In some configurations, an alternative Cartesian representation may be chosen by the sensing entity. Accordingly, the sensing entity may specify the Cartesian representation in the configuration for point cloud reporting. If the Cartesian representation is requested, the reporting network entity may map (convert) the default polar representation (e.g., an (r, theta) representation) to 2D or three-dimensional (3D) Cartesian representation (e.g., an (x-coordinate, y-coordinate) representation) (e.g., depending on the configuration and/or the reporting network entity/node capability), and may use the (2D or 3D) Cartesian representation (e.g., an (x-coordinate, y-coordinate) representation) in the report instead of the polar representation (i.e., the (range r, angle theta) representation).

In one or more configurations, if the orientation and/or position of the reporting network entity (e.g., a UE, a TRP, or a base station) is known or may be ascertained, the reporting network entity may provide the orientation and/or position information to the sensing entity as part of the sensing reporting. The orientation and/or position information about the reporting network entity may be used (e.g., by the sensing entity) for fusing the point clouds at a later stage.

Further, in one configuration, the reporting network entity (e.g., a UE, a TRP, or a base station) may report point clouds individually for each frequency layer used in the sensing. In another configuration, the reporting network entity (e.g., a UE, a TRP, or a base station) may report point clouds across multiple frequencies used in the sensing (e.g., after performing fusion across the multiple frequency layers corresponding to the multiple frequencies).

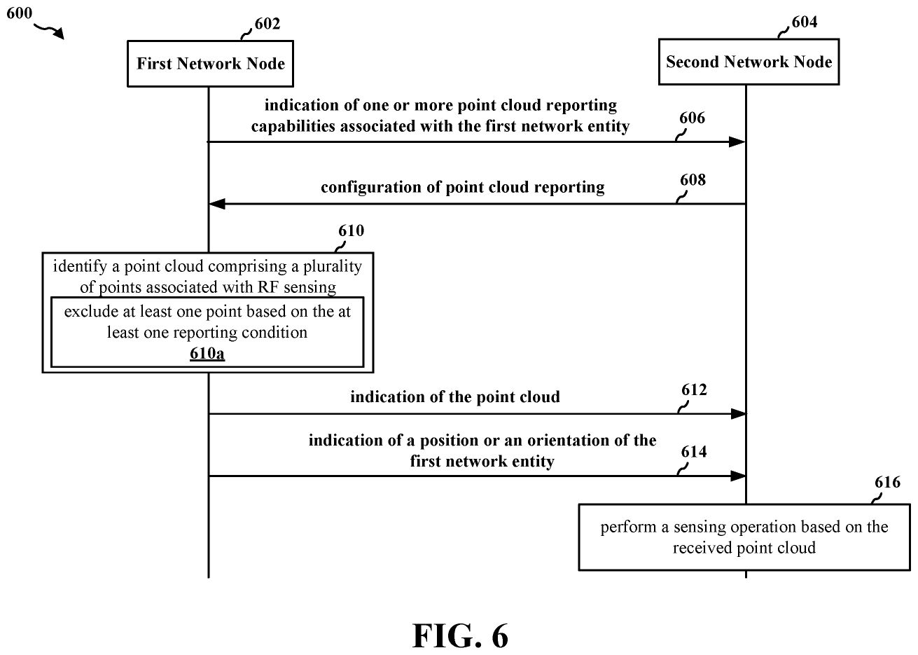

FIG. 6 is a diagram of a communication flow 600 of a method of wireless communication. The first network entity 602 may implement aspects of the UE 104/350 or the base station 102/310. The second network entity 604 may implement aspects of a sensing entity. Accordingly, the first network entity 602 may include at least one of a UE, a TRP, or a base station. The second network entity 604 may include a sensing entity in a wireless communication system.

At 606, the first network entity 602 may transmit, for the second network entity 604, a second indication of one or more point cloud reporting capabilities associated with the first network entity 602. The one or more point cloud reporting capabilities may correspond to one or more of one or more reported parameters, a coordinate system, a reporting format, one or more frequencies, at least one antenna configuration, or a beam pattern configuration.

At 608, the second network entity 604 may transmit a configuration of point cloud reporting to the first network entity 602. The configuration of point cloud reporting may correspond to one or more of a sensing reference signal configuration, a reporting frequency, or a reporting format. The reporting format may correspond to full reporting or differential reporting.

In one or more configurations, the configuration of point cloud reporting may further correspond to one or more of a velocity compensation mode, at least one reporting condition, or a representation system.

At 610, the first network entity 602 may identify a point cloud including a plurality of points associated with RF sensing.

In one configuration, the point cloud may be based on one or more radar data cubes.

In one or more configurations, each point in the plurality of points may be associated with at least one of a range, a velocity, or one or more angles.

In one or more configurations, the point cloud may be associated with a local coordinate system associated with the first network entity 602 or a global coordinate system.

In one configuration, the configuration of point cloud reporting may include at least the at least one reporting condition. Accordingly, to identify, at 610, the point cloud, at 610a, the first network entity 602 may exclude at least one point from the point cloud based on the at least one reporting condition.

In one or more configurations, the point cloud may be associated with a single frequency layer or a plurality of frequency layers.

At 612, the first network entity 602 may transmit an indication of the point cloud for the second network entity 604.

At 614, the second network entity 604 may receive a second indication of a position or an orientation of the first network entity 602 from the first network entity 602.

At 616, the second network entity 604 may perform a sensing operation based on the received point cloud.

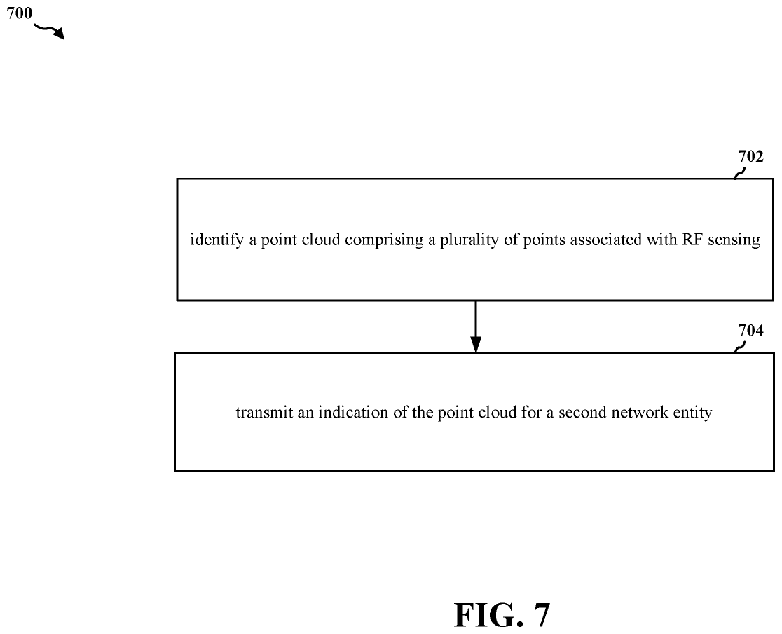

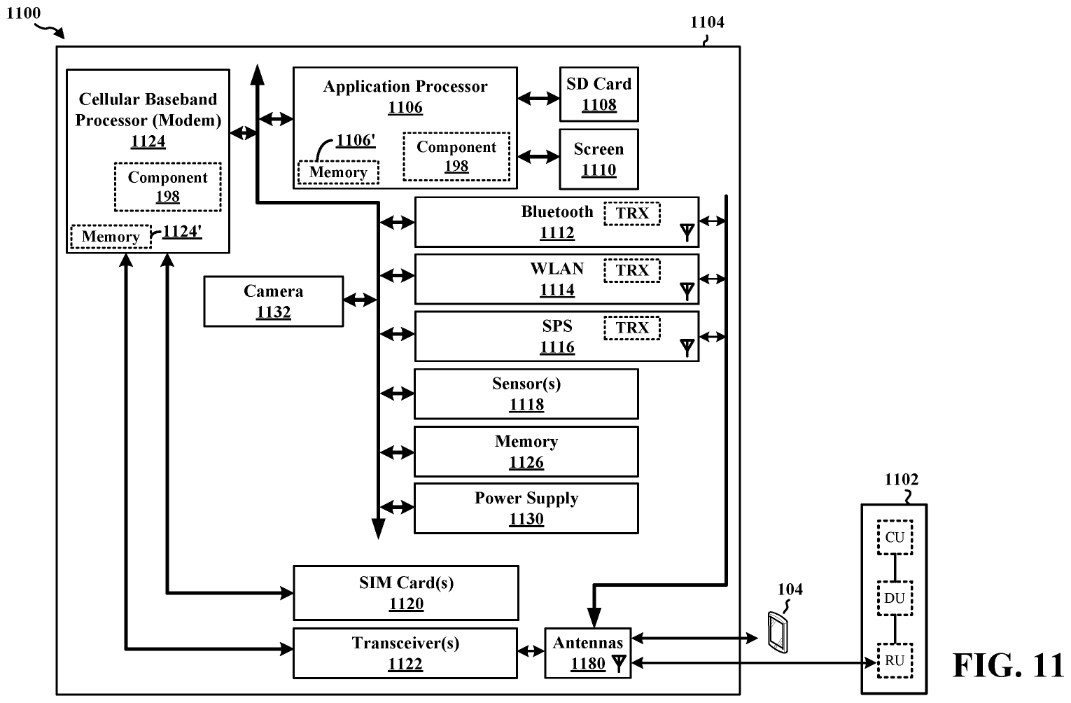

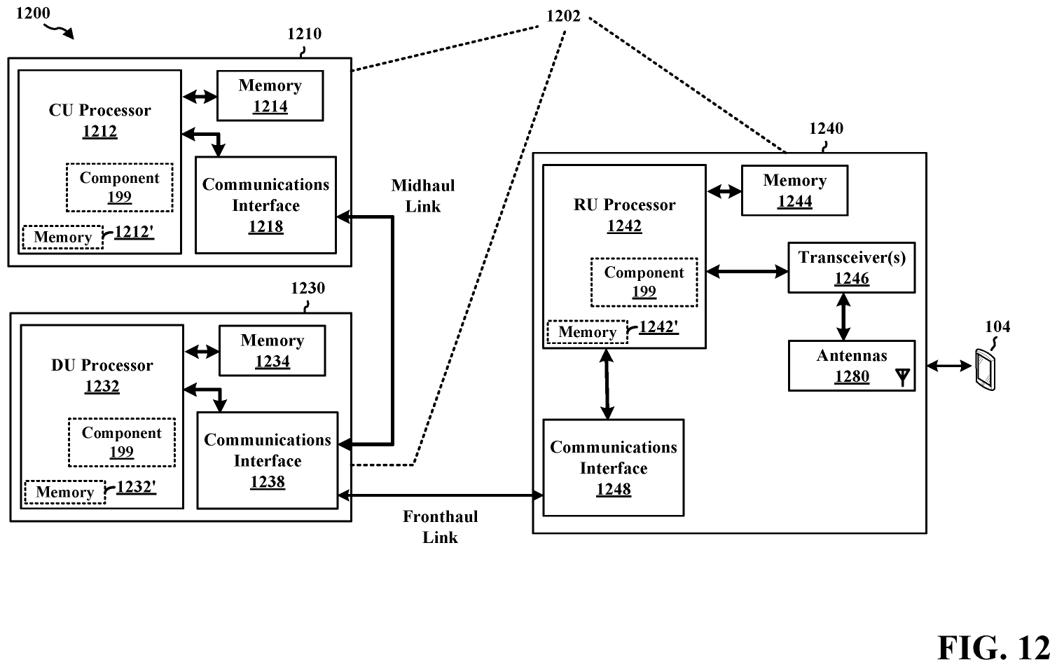

FIG. 7 is a flowchart 700 of a method of wireless communication. The method may be performed by a first network entity (e.g., the UE 104/350; the apparatus 1104; the base station 102/310; the network entity 1102; the first network entity 602). At 702, the first network entity may identify a point cloud including a plurality of points associated with RF sensing. For example, 702 may be performed by the component 198 in FIG. 11 or the component 199 in FIG. 12. Referring to FIG. 6, at 610, the first network entity 602 may identify a point cloud including a plurality of points associated with RF sensing.

At 704, the first network entity may transmit an indication of the point cloud for a second network entity. For example, 704 may be performed by the component 198 in FIG. 11 or the component 199 in FIG. 12. Referring to FIG. 6, at 612, the first network entity 602 may transmit an indication of the point cloud for a second network entity 604.

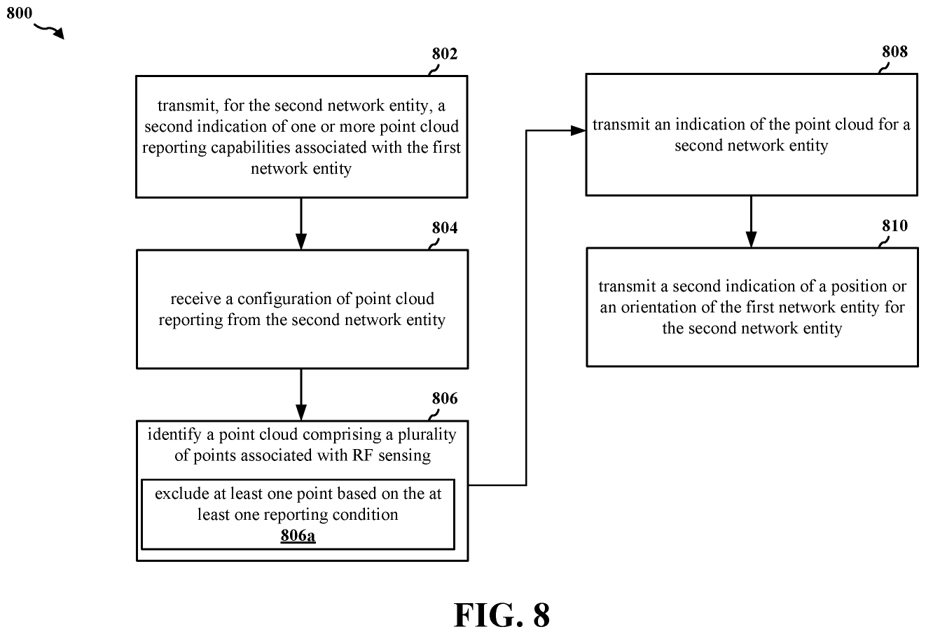

FIG. 8 is a flowchart 800 of a method of wireless communication. The method may be performed by a first network entity (e.g., the UE 104/350; the apparatus 1104; the base station 102/310; the network entity 1102; the first network entity 602). At 806, the first network entity may identify a point cloud including a plurality of points associated with RF sensing. For example, 806 may be performed by the component 198 in FIG. 11 or the component 199 in FIG. 12. Referring to FIG. 6, at 610, the first network entity 602 may identify a point cloud including a plurality of points associated with RF sensing.

At 810, the first network entity may transmit an indication of the point cloud for a second network entity. For example, 810 may be performed by the component 198 in FIG. 11 or the component 199 in FIG. 12. Referring to FIG. 6, at 612, the first network entity 602 may transmit an indication of the point cloud for a second network entity 604.

In one configuration, the point cloud may be based on one or more radar data cubes.

In one configuration, each point in the plurality of points is associated with at least one of a range, a velocity, or one or more angles.

In one configuration, referring to FIG. 6, the point cloud may be associated with a local coordinate system associated with the first network entity 602 or a global coordinate system.

In one configuration, at 802, the first network entity may transmit, for the second network entity, a second indication of one or more point cloud reporting capabilities associated with the first network entity. The one or more point cloud reporting capabilities may correspond to one or more of one or more reported parameters, a coordinate system, a reporting format, one or more frequencies, at least one antenna configuration, or a beam pattern configuration. For example, 802 may be performed by the component 198 in FIG. 11 or the component 199 in FIG. 12. Referring to FIG. 6, at 606, the first network entity 602 may transmit, for the second network entity 604, a second indication of one or more point cloud reporting capabilities associated with the first network entity 602.

In one configuration, at 804, the first network entity may receive a configuration of point cloud reporting from the second network entity. The configuration of point cloud reporting may correspond to one or more of a sensing reference signal configuration, a reporting frequency, or a reporting format. The reporting format may correspond to full reporting or differential reporting. For example, 804 may be performed by the component 198 in FIG. 11 or the component 199 in FIG. 12. Referring to FIG. 6, at 608, the first network entity 602 may receive a configuration of point cloud reporting from the second network entity 604.

In one configuration, referring to FIG. 6, the configuration of point cloud reporting, at 608, may further correspond to one or more of a velocity compensation mode, at least one reporting condition, or a representation system.

In one configuration, referring to FIG. 6, the configuration of point cloud reporting, at 608, may further correspond to at least the at least one reporting condition. To identify the point cloud, at 806a, the first network entity may exclude at least one point from the point cloud based on the at least one reporting condition. For example, 806a may be performed by the component 198 in FIG. 11 or the component 199 in FIG. 12. Referring to FIG. 6, at 610a, the first network entity 602 may exclude at least one point from the point cloud based on the at least one reporting condition.

In one configuration, at 808, the first network entity may transmit a second indication of a position or an orientation of the first network entity for the second network entity. For example, 808 may be performed by the component 198 in FIG. 11 or the component 199 in FIG. 12. Referring to FIG. 6, at 614, the first network entity 602 may transmit a second indication of a position or an orientation of the first network entity 602 for the second network entity 604.

In one configuration, the point cloud may be associated with a single frequency layer or a plurality of frequency layers.

In one configuration, referring to FIG. 6, the first network entity 602 may include at least one of a UE, a TRP, or a base station. The second network entity 604 may include a sensing entity in a wireless communication system.

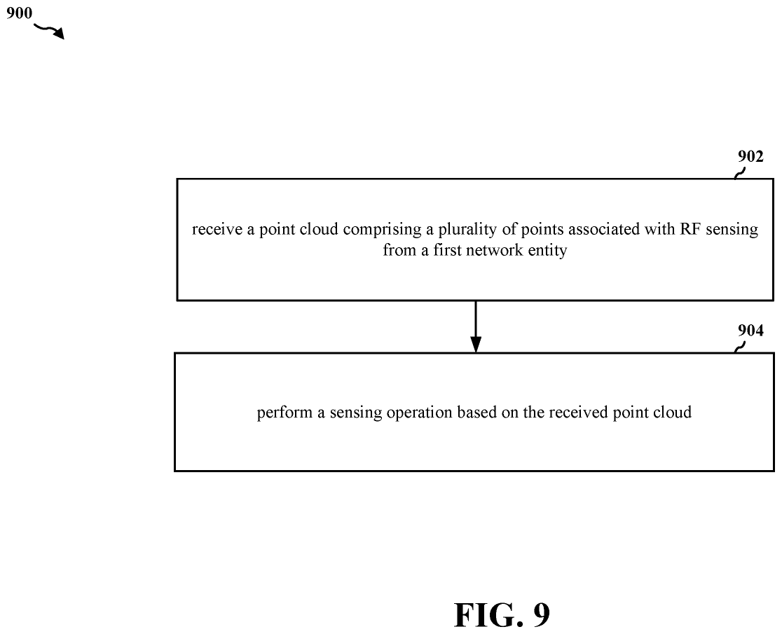

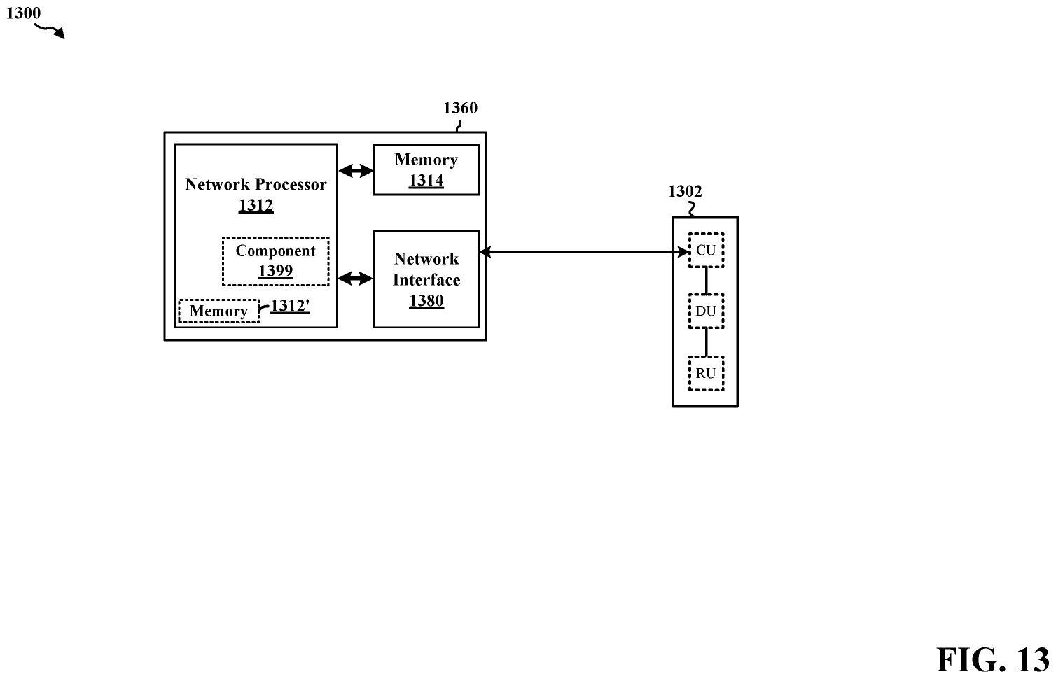

FIG. 9 is a flowchart 900 of a method of wireless communication. The method may be performed by a second network entity (e.g., a sensing entity; the second network entity 604; the network entity 1360). At 902, the second network entity may receive a point cloud including a plurality of points associated with RF sensing from a first network entity. For example, 902 may be performed by the component 1399 in FIG. 13. Referring to FIG. 6, at 612, the second network entity 604 may receive a point cloud including a plurality of points associated with RF sensing from a first network entity 602.

At 904, the second network entity may perform a sensing operation based on the received point cloud. For example, 904 may be performed by the component 1399 in FIG. 13. Referring to FIG. 6, at 616, the second network entity 604 may perform a sensing operation based on the received point cloud.

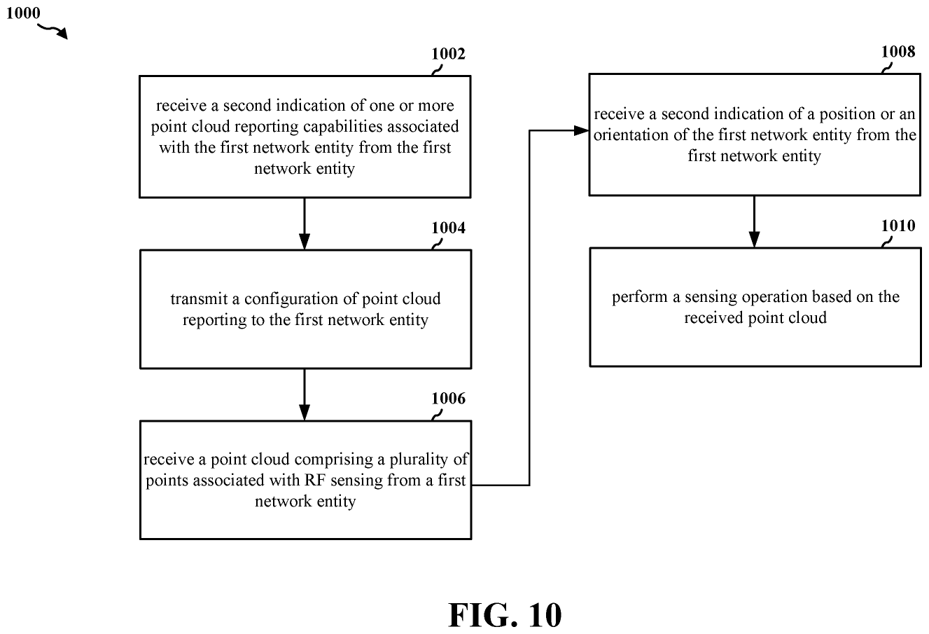

FIG. 10 is a flowchart 1000 of a method of wireless communication. The method may be performed by a second network entity (e.g., a sensing entity; the second network entity 604; the network entity 1360). At 1006, the second network entity may receive a point cloud including a plurality of points associated with RF sensing from a first network entity. For example, 1006 may be performed by the component 1399 in FIG. 13. Referring to FIG. 6, at 612, the second network entity 604 may receive a point cloud including a plurality of points associated with RF sensing from a first network entity 602.

At 1010, the second network entity may perform a sensing operation based on the received point cloud. For example, 1010 may be performed by the component 1399 in FIG. 13. Referring to FIG. 6, at 616, the second network entity 604 may perform a sensing operation based on the received point cloud.

In one configuration, the point cloud may be based on one or more radar data cubes.

In one configuration, each point in the plurality of points may be associated with at least one of a range, a velocity, or one or more angles.

In one configuration, referring to FIG. 6, the point cloud may be associated with a local coordinate system associated with the first network entity 602 or a global coordinate system.

In one configuration, at 1002, the second network entity may receive a second indication of one or more point cloud reporting capabilities associated with the first network entity from the first network entity. The one or more point cloud reporting capabilities may correspond to one or more of one or more reported parameters, a coordinate system, a reporting format, one or more frequencies, at least one antenna configuration, or a beam pattern configuration. For example, 1002 may be performed by the component 1399 in FIG. 13. Referring to FIG. 6, at 606, the second network entity 604 may receive a second indication of one or more point cloud reporting capabilities associated with the first network entity 602 from the first network entity 602.

In one configuration, at 1004, the second network entity may transmit a configuration of point cloud reporting to the first network entity. The configuration of point cloud reporting may correspond to one or more of a sensing reference signal configuration, a reporting frequency, or a reporting format. The reporting format may correspond to full reporting or differential reporting. For example, 1004 may be performed by the component 1399 in FIG. 13. Referring to FIG. 6, at 608, the second network entity 604 may transmit a configuration of point cloud reporting to the first network entity 602.

In one configuration, referring to FIG. 6, the configuration of point cloud reporting, at 1004, may further correspond to one or more of a velocity compensation mode, at least one reporting condition, or a representation system.

In one configuration, at 1008, the second network entity may receive a second indication of a position or an orientation of the first network entity from the first network entity. For example, 1008 may be performed by the component 1399 in FIG. 13. Referring to FIG. 6, at 614, the second network entity 604 may receive a second indication of a position or an orientation of the first network entity 602 from the first network entity 602.

In one configuration, the point cloud may be associated with a single frequency layer or a plurality of frequency layers.

In one configuration, referring to FIG. 6, the first network entity 602 may include at least one of a UE, a TRP, or a base station. The second network entity 604 may include a sensing entity in a wireless communication system.

FIG. 11 is a diagram 1100 illustrating an example of a hardware implementation for an apparatus 1104. The apparatus 1104 may be a UE, a component of a UE, or may implement UE functionality. In some aspects, the apparatus1104 may include a cellular baseband processor 1124 (also referred to as a modem) coupled to one or more transceivers 1122 (e.g., cellular RF transceiver). The cellular baseband processor 1124 may include on-chip memory 1124′. In some aspects, the apparatus 1104 may further include one or more subscriber identity modules (SIM) cards 1120 and an application processor 1106 coupled to a secure digital (SD) card 1108 and a screen 1110. The application processor 1106 may include on-chip memory 1106′. In some aspects, the apparatus 1104 may further include a Bluetooth module 1112, a WLAN module 1114, an SPS module 1116 (e.g., GNSS module), one or more sensor modules 1118 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1126, a power supply 1130, and/or a camera 1132. The Bluetooth module 1112, the WLAN module 1114, and the SPS module 1116 may include an on-chip transceiver (TRX) (or in some cases, just a receiver (RX)). The Bluetooth module 1112, the WLAN module 1114, and the SPS module 1116 may include their own dedicated antennas and/or utilize the antennas 1180 for communication. The cellular baseband processor 1124 communicates through the transceiver(s) 1122 via one or more antennas 1180 with the UE 104 and/or with an RU associated with a network entity 1102. The cellular baseband processor 1124 and the application processor 1106 may each include a computer-readable medium/memory 1124′, 1106′, respectively. The additional memory modules 1126 may also be considered a computer-readable medium/memory. Each computer-readable medium/memory 1124′, 1106′, 1126 may be non-transitory. The cellular baseband processor 1124 and the application processor 1106 are each responsible for general processing, including the execution of software stored on the computer-readable medium/memory. The software, when executed by the cellular baseband processor 1124/application processor 1106, causes the cellular baseband processor 1124/application processor 1106 to perform the various functions described supra. The computer-readable medium/memory may also be used for storing data that is manipulated by the cellular baseband processor 1124/application processor 1106 when executing software. The cellular baseband processor 1124/application processor 1106 may be a component of the UE 350 and may include the memory 360 and/or at least one of the TX processor 368, the RX processor 356, and the controller/processor 359. In one configuration, the apparatus 1104 may be a processor chip (modem and/or application) and include just the cellular baseband processor 1124 and/or the application processor 1106, and in another configuration, the apparatus 1104 may be the entire UE (e.g., see 350 of FIG. 3) and include the additional modules of the apparatus 1104.

As discussed supra, the component 198 is configured to identify a point cloud including a plurality of points associated with RF sensing. The component 198 is configured to transmit an indication of the point cloud for a second network entity. The component 198 may be within the cellular baseband processor 1124, the application processor 1106, or both the cellular baseband processor 1124 and the application processor 1106. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1104 may include a variety of components configured for various functions. In one configuration, the apparatus 1104, and in particular the cellular baseband processor 1124 and/or the application processor 1106, includes means for identifying a point cloud including a plurality of points associated with RF sensing. The apparatus 1104, and in particular the cellular baseband processor 1124 and/or the application processor 1106, includes means for transmitting an indication of the point cloud for a second network entity.

In one configuration, the point cloud may be based on one or more radar data cubes. In one configuration, each point in the plurality of points may be associated with at least one of a range, a velocity, or one or more angles. In one configuration, the point cloud may be associated with a local coordinate system associated with the first network entity or a global coordinate system. In one configuration, the apparatus 1104, and in particular the cellular baseband processor 1124 and/or the application processor 1106, includes means for transmitting, for the second network entity, a second indication of one or more point cloud reporting capabilities associated with the first network entity. The one or more point cloud reporting capabilities may correspond to one or more of one or more reported parameters, a coordinate system, a reporting format, one or more frequencies, at least one antenna configuration, or a beam pattern configuration. In one configuration, the apparatus 1104, and in particular the cellular baseband processor 1124 and/or the application processor 1106, includes means for receiving a configuration of point cloud reporting from the second network entity. The configuration of point cloud reporting may correspond to one or more of a sensing reference signal configuration, a reporting frequency, or a reporting format. The reporting format may correspond to full reporting or differential reporting. In one configuration, the configuration of point cloud reporting may further correspond to one or more of a velocity compensation mode, at least one reporting condition, or a representation system. In one configuration, the configuration of point cloud reporting may further correspond to at least the at least one reporting condition. The means for identifying the point cloud may be further configured to exclude at least one point from the point cloud based on the at least one reporting condition. In one configuration, the apparatus 1104, and in particular the cellular baseband processor 1124 and/or the application processor 1106, includes means for transmitting a second indication of a position or an orientation of the first network entity for the second network entity. In one configuration, the point cloud may be associated with a single frequency layer or a plurality of frequency layers. In one configuration, the first network entity may include at least one of a UE, a TRP, or a base station. The second network entity may include a sensing entity in a wireless communication system.

The means may be the component 198 of the apparatus 1104 configured to perform the functions recited by the means. As described supra, the apparatus 1104 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 12 is a diagram 1200 illustrating an example of a hardware implementation for a network entity 1202. The network entity 1202 may be a BS, a component of a BS, or may implement BS functionality. The network entity 1202 may include at least one of a CU 1210, a DU 1230, or an RU 1240. For example, depending on the layer functionality handled by the component 199, the network entity 1202 may include the CU 1210; both the CU 1210 and the DU 1230; each of the CU 1210, the DU 1230, and the RU 1240; the DU 1230; both the DU 1230 and the RU 1240; or the RU 1240. The CU 1210 may include a CU processor 1212. The CU processor 1212 may include on-chip memory 1212′. In some aspects, the CU 1210 may further include additional memory modules 1214 and a communications interface 1218. The CU 1210 communicates with the DU 1230 through a midhaul link, such as an F1 interface. The DU 1230 may include a DU processor 1232. The DU processor 1232 may include on-chip memory 1232′. In some aspects, the DU 1230 may further include additional memory modules 1234 and a communications interface 1238. The DU 1230 communicates with the RU 1240 through a fronthaul link. The RU 1240 may include an RU processor 1242. The RU processor 1242 may include on-chip memory 1242′. In some aspects, the RU 1240 may further include additional memory modules 1244, one or more transceivers 1246, antennas 1280, and a communications interface 1248. The RU 1240 communicates with the UE 104. The on-chip memory 1212′, 1232′, 1242′ and the additional memory modules 1214, 1234, 1244 may each be considered a computer-readable medium/memory. Each computer-readable medium/memory may be non-transitory. Each of the processors 1212, 1232, 1242 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 is configured to identify a point cloud including a plurality of points associated with RF sensing. The component 199 is configured to transmit an indication of the point cloud for a second network entity. The component 199 may be within one or more processors of one or more of the CU 1210, DU 1230, and the RU 1240. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1202 may include a variety of components configured for various functions. In one configuration, the network entity 1202 includes means for identifying a point cloud including a plurality of points associated with RF sensing. The network entity 1202 includes means for transmitting an indication of the point cloud for a second network entity.

In one configuration, the point cloud may be based on one or more radar data cubes. In one configuration, each point in the plurality of points may be associated with at least one of a range, a velocity, or one or more angles. In one configuration, the point cloud may be associated with a local coordinate system associated with the first network entity or a global coordinate system. In one configuration, the network entity 1202 includes means for transmitting, for the second network entity, a second indication of one or more point cloud reporting capabilities associated with the first network entity. The one or more point cloud reporting capabilities may correspond to one or more of one or more reported parameters, a coordinate system, a reporting format, one or more frequencies, at least one antenna configuration, or a beam pattern configuration. In one configuration, the network entity 1202 includes means for receiving a configuration of point cloud reporting from the second network entity. The configuration of point cloud reporting may correspond to one or more of a sensing reference signal configuration, a reporting frequency, or a reporting format. The reporting format may correspond to full reporting or differential reporting. In one configuration, the configuration of point cloud reporting may further correspond to one or more of a velocity compensation mode, at least one reporting condition, or a representation system. In one configuration, the configuration of point cloud reporting may further correspond to at least the at least one reporting condition. The means for identifying the point cloud may be further configured to exclude at least one point from the point cloud based on the at least one reporting condition. In one configuration, the network entity 1202 includes means for transmitting a second indication of a position or an orientation of the first network entity for the second network entity. In one configuration, the point cloud may be associated with a single frequency layer or a plurality of frequency layers. In one configuration, the first network entity may include at least one of a UE, a TRP, or a base station. The second network entity may include a sensing entity in a wireless communication system.

The means may be the component 199 of the network entity 1202 configured to perform the functions recited by the means. As described supra, the network entity 1202 may include the TX processor 316, the RX processor 370, and the controller/processor 375. As such, in one configuration, the means may be the TX processor 316, the RX processor 370, and/or the controller/processor 375 configured to perform the functions recited by the means.

FIG. 13 is a diagram 1300 illustrating an example of a hardware implementation for a network entity 1360. In one example, the network entity 1360 may be within the core network 120. The network entity 1360 may include a network processor 1312. The network processor 1312 may include on-chip memory 1312′. In some aspects, the network entity 1360 may further include additional memory modules 1314. The network entity 1360 communicates via the network interface 1380 directly (e.g., backhaul link) or indirectly (e.g., through a MC) with the CU 1302. The on-chip memory 1312′ and the additional memory modules 1314 may each be considered a computer-readable medium/memory. Each computer-readable medium/memory may be non-transitory. The processor 1312 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 1399 is configured to receive a point cloud including a plurality of points associated with RF sensing from a first network entity. The component 1399 is configured to perform a sensing operation based on the received point cloud. The component 1399 may be within the processor 1312. The component 1399 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1360 may include a variety of components configured for various functions. In one configuration, the network entity 1360 includes means for receiving a point cloud including a plurality of points associated with RF sensing from a first network entity. The network entity 1360 includes means for performing a sensing operation based on the received point cloud.

In one configuration, the point cloud may be based on one or more radar data cubes. In one configuration, each point in the plurality of points may be associated with at least one of a range, a velocity, or one or more angles. In one configuration, the point cloud may be associated with a local coordinate system associated with the first network entity or a global coordinate system. In one configuration, the network entity 1360 includes means for receiving a second indication of one or more point cloud reporting capabilities associated with the first network entity from the first network entity. The one or more point cloud reporting capabilities may correspond to one or more of one or more reported parameters, a coordinate system, a reporting format, one or more frequencies, at least one antenna configuration, or a beam pattern configuration. In one configuration, the network entity 1360 includes means for transmitting a configuration of point cloud reporting to the first network entity. The configuration of point cloud reporting may correspond to one or more of a sensing reference signal configuration, a reporting frequency, or a reporting format. The reporting format may correspond to full reporting or differential reporting. In one configuration, the configuration of point cloud reporting may further correspond to one or more of a velocity compensation mode, at least one reporting condition, or a representation system. In one configuration, the network entity 1360 includes means for receiving a second indication of a position or an orientation of the first network entity from the first network entity. In one configuration, the point cloud may be associated with a single frequency layer or a plurality of frequency layers. In one configuration, the first network entity may include at least one of a UE, a TRP, or a base station. The second network entity may include a sensing entity in a wireless communication system.

The means may be the component 1399 of the network entity 1360 configured to perform the functions recited by the means.

Referring back to FIGS. 4-13, a first network entity may identify a point cloud including a plurality of points associated with RF sensing. The first network entity may transmit an indication of the point cloud for a second network entity. The second network entity may perform a sensing operation based on the received point cloud. Accordingly, the reporting of point clouds to a sensing entity by a reporting network entity may be enabled.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a first network entity, including identifying a point cloud including a plurality of points associated with RF sensing; and transmitting an indication of the point cloud for a second network entity.

Aspect 2 may be combined with aspect 1 and includes that the point cloud is based on one or more radar data cubes.

Aspect 3 may be combined with any of aspects 1 and 2 and includes that each point in the plurality of points is associated with at least one of a range, a velocity, or one or more angles.

Aspect 4 may be combined with any of aspects 1-3 and includes that the point cloud is associated with a local coordinate system associated with the first network entity or a global coordinate system.

Aspect 5 may be combined with any of aspects 1-4 and further includes: transmitting, for the second network entity, a second indication of one or more point cloud reporting capabilities associated with the first network entity, where the one or more point cloud reporting capabilities correspond to one or more of one or more reported parameters, a coordinate system, a reporting format, one or more frequencies, at least one antenna configuration, or a beam pattern configuration.

Aspect 6 may be combined with any of aspects 1-5 and further includes: receiving a configuration of point cloud reporting from the second network entity, where the configuration of point cloud reporting corresponds to one or more of a sensing reference signal configuration, a reporting frequency, or a reporting format, and where the reporting format corresponds to full reporting or differential reporting.

Aspect 7 may be combined with aspect 6 and includes that the configuration of point cloud reporting further corresponds to one or more of a velocity compensation mode, at least one reporting condition, or a representation system.

Aspect 8 may be combined with aspect 7 and includes that the configuration of point cloud reporting further corresponds to at least the at least one reporting condition, and to identify the point cloud, the at least one processor is further configured to exclude at least one point from the point cloud based on the at least one reporting condition.

Aspect 9 may be combined with any of aspects 1-8 and further includes: transmitting a second indication of a position or an orientation of the first network entity for the second network entity.

Aspect 10 may be combined with any of aspects 1-9 and includes that the point cloud is associated with a single frequency layer or a plurality of frequency layers.

Aspect 11 may be combined with any of aspects 1-10 and includes that the first network entity includes at least one of a UE, a TRP, or a base station, and where the second network entity includes a sensing entity in a wireless communication system.

Aspect 12 is a method of wireless communication at a second network entity, including receiving a point cloud including a plurality of points associated with RF sensing from a first network entity; and performing a sensing operation based on the received point cloud.

Aspect 13 may be combined with aspect 12 and includes that the point cloud is based on one or more radar data cubes.

Aspect 14 may be combined with any of aspects 12 and 13 and includes that each point in the plurality of points is associated with at least one of a range, a velocity, or one or more angles.

Aspect 15 may be combined with any of aspects 12-14 and includes that the point cloud is associated with a local coordinate system associated with the first network entity or a global coordinate system.

Aspect 16 may be combined with any of aspects 12-15 and further includes: receiving a second indication of one or more point cloud reporting capabilities associated with the first network entity from the first network entity, where the one or more point cloud reporting capabilities correspond to one or more of one or more reported parameters, a coordinate system, a reporting format, one or more frequencies, at least one antenna configuration, or a beam pattern configuration.

Aspect 17 may be combined with any of aspects 12-16 and further includes: transmitting a configuration of point cloud reporting to the first network entity, where the configuration of point cloud reporting corresponds to one or more of a sensing reference signal configuration, a reporting frequency, or a reporting format, and where the reporting format corresponds to full reporting or differential reporting.

Aspect 18 may be combined with aspect 17 and includes that the configuration of point cloud reporting further corresponds to one or more of a velocity compensation mode, at least one reporting condition, or a representation system.

Aspect 19 may be combined with any of aspects 12-18 and further includes: receiving a second indication of a position or an orientation of the first network entity from the first network entity.

Aspect 20 may be combined with any of aspects 12-19 and includes that the point cloud is associated with a single frequency layer or a plurality of frequency layers.

Aspect 21 may be combined with any of aspects 12-20 and includes that the first network entity includes at least one of a UE, a TRP, or a base station, and where the second network entity includes a sensing entity in a wireless communication system.

Aspect 22 is an apparatus for wireless communication including at least one processor coupled to a memory and, based at least in part on information stored in the memory, the at least one processor is configured to implement a method as in any of aspects 1-21.

Aspect 23 may be combined with aspect 22 and further includes a transceiver coupled to the at least one processor.

Aspect 24 is an apparatus for wireless communication including means for implementing any of aspects 1-21.

Aspect 25 is a non-transitory computer-readable storage medium storing computer executable code, where the code when executed by a processor causes the processor to implement any of aspects 1-21.

Various aspects have been described herein. These and other aspects are within the scope of the following claims.

What is claimed is:

1. An apparatus for wireless communication at a first network entity, comprising:
a memory; and
at least one processor coupled to the memory and, based at least in part on information stored in the memory, the at least one processor is configured to:
identify a point cloud comprising a plurality of points associated with radio frequency (RF) sensing; and
transmit an indication of the point cloud for a second network entity.

2. The apparatus of claim 1, wherein the point cloud is based on one or more radar data cubes.

3. The apparatus of claim 1, wherein each point in the plurality of points is associated with at least one of a range, a velocity, or one or more angles.

4. The apparatus of claim 1, wherein the point cloud is associated with a local coordinate system associated with the first network entity or a global coordinate system.

5. The apparatus of claim 1, the at least one processor being further configured to:
transmit, for the second network entity, a second indication of one or more point cloud reporting capabilities associated with the first network entity, wherein the one or more point cloud reporting capabilities correspond to one or more of one or more reported parameters, a coordinate system, a reporting format, one or more frequencies, at least one antenna configuration, or a beam pattern configuration.

6. The apparatus of claim 1, the at least one processor being further configured to:
receive a configuration of point cloud reporting from the second network entity, wherein the configuration of point cloud reporting corresponds to one or more of a sensing reference signal configuration, a reporting frequency, or a reporting format, and wherein the reporting format corresponds to full reporting or differential reporting.

7. The apparatus of claim 6, wherein the configuration of the point cloud reporting further corresponds to one or more of a velocity compensation mode, at least one reporting condition, or a representation system.

8. The apparatus of claim 7, wherein the configuration of the point cloud reporting further corresponds to at least the at least one reporting condition, and to identify the point cloud, the at least one processor is further configured to exclude at least one point from the point cloud based on the at least one reporting condition.

9. The apparatus of claim 1, the at least one processor being further configured to:
transmit a second indication of a position or an orientation of the first network entity for the second network entity.

10. The apparatus of claim 1, wherein the point cloud is associated with a single frequency layer or a plurality of frequency layers.

11. The apparatus of claim 1, wherein the first network entity comprises at least one of a user equipment (UE), a transmit receive point (TRP), or a base station, and wherein the second network entity comprises a sensing entity in a wireless communication system.

12. The apparatus of claim 1, further comprising a transceiver coupled to the at least one processor, wherein to transmit the indication of the point cloud, the at least one processor is configured to: transmit, via the transceiver, the indication of the point cloud.

13. A method of wireless communication at a first network entity, comprising:
identifying a point cloud comprising a plurality of points associated with radio frequency (RF) sensing; and
transmitting an indication of the point cloud for a second network entity.

14. The method of claim 13, wherein the point cloud is based on one or more radar data cubes.

15. The method of claim 13, wherein each point in the plurality of points is associated with at least one of a range, a velocity, or one or more angles.

16. An apparatus for wireless communication at a second network entity, comprising:
a memory; and
at least one processor coupled to the memory and, based at least in part on information stored in the memory, the at least one processor is configured to:
receive a point cloud comprising a plurality of points associated with radio frequency (RF) sensing from a first network entity; and
perform a sensing operation based on the received point cloud.

17. The apparatus of claim 16, wherein the point cloud is based on one or more radar data cubes.

18. The apparatus of claim 16, wherein each point in the plurality of points is associated with at least one of a range, a velocity, or one or more angles.

19. The apparatus of claim 16, wherein the point cloud is associated with a local coordinate system associated with the first network entity or a global coordinate system.

20. The apparatus of claim 16, the at least one processor being further configured to:
receive a second indication of one or more point cloud reporting capabilities associated with the first network entity from the first network entity, wherein the one or more point cloud reporting capabilities correspond to one or more of one or more reported parameters, a coordinate system, a reporting format, one or more frequencies, at least one antenna configuration, or a beam pattern configuration.

21. The apparatus of claim 16, the at least one processor being further configured to:
transmit a configuration of point cloud reporting to the first network entity, wherein the configuration of point cloud reporting corresponds to one or more of a sensing reference signal configuration, a reporting frequency, or a reporting format, and wherein the reporting format corresponds to full reporting or differential reporting.

22. The apparatus of claim 21, wherein the configuration of the point cloud reporting further corresponds to one or more of a velocity compensation mode, at least one reporting condition, or a representation system.

23. The apparatus of claim 16, the at least one processor being further configured to:
receive a second indication of a position or an orientation of the first network entity from the first network entity.

24. The apparatus of claim 16, wherein the point cloud is associated with a single frequency layer or a plurality of frequency layers.

25. The apparatus of claim 16, wherein the first network entity comprises at least one of a user equipment (UE), a transmit receive point (TRP), or a base station, and wherein the second network entity comprises a sensing entity in a wireless communication system.

26. The apparatus of claim 16, further comprising a transceiver coupled to the at least one processor, wherein to receive the point cloud comprising the plurality of points, the at least one processor is configured to: receive, via the transceiver, the point cloud comprising the plurality of points.

27. A method of wireless communication at a second network entity, comprising:
receiving a point cloud comprising a plurality of points associated with radio frequency (RF) sensing from a first network entity; and
performing a sensing operation based on the received point cloud.

28. The method of claim 27, wherein the point cloud is based on one or more radar data cubes.

29. The method of claim 27, wherein each point in the plurality of points is associated with at least one of a range, a velocity, or one or more angles.

30. The method of claim 27, wherein the point cloud is associated with a local coordinate system associated with the first network entity or a global coordinate system.
